(19) United States
(12) Patent Application Publication
(10) Pub. No.: US 2026/0339017 A1
(43) Pub. Date: Oct. 29, 2026

(54) LIGHT GUIDING ROD OF END SURFACE LIGHT EMITTING TYPE AND PRODUCTION METHOD OF SAME

(71) Applicant: FUKUVI CHEMICAL INDUSTRY CO.,LTD., Fukui-shi, Fukui (JP)

(72) Inventors: Yuto USUI, Fukui-shi (JP); Tatsuya YAMAZAKI, Fukui-shi (JP)

(73) Assignee: FUKUVI CHEMICAL INDUSTRY CO., LTD., Fukui-shi, Fukui (JP)

(21) Appl. No.: 19/104,978

(22) PCT Filed: Sep. 27, 2023
(86) PCT No.: PCT/JP2023/035310

§ 371 Date: Feb. 19, 2025

(30) Foreign Application Priority Data
Sep. 28, 2022 (JP) 2022-155230

(51) Int. Cl. G02B 6/036; G02B 5/00; G02B 6/02; G02B 6/44

(52) U.S. Cl. CPC G02B 6/03622; G02B 5/003; G02B 6/02033; G02B 6/4402

(57) ABSTRACT

A light guiding rod of end surface light emitting type in which the light components do not leak from the periphery, which is capable of efficiently guiding the light components and a method of producing the rod. The light guiding rod including a bar-shaped cored layer made from a resin having permeability of light and a clad layer disposed on an outer periphery of the cored layer, made from a resin whose refractive index is lower than that of the cored layer and emitting light incident on one end surface of the cored layer from the other end surface thereof, wherein a light shielding layer made from a resin having a property to absorb the wavelengths of the light components penetrating through the cored layer is disposed on an outer periphery of the clad layer and the light-shielding layer is integrally fused to the clad layer.

### TECHNICAL FIELD

The present invention relates to a light guiding rod of end surface light emitting type and a method of producing the same that enable a light emitting element and a light emitting section to be locationally disposed differently from each other by making light incident on one end surface emitted from the other end surface.

### BACKGROUND ART

Most of the products with electricity in use such as industrial machinery, electric appliances and automobiles are provided with an indicator emitting light of a prescribed color for the purpose of informing the users of the operational statuses and for the decorative purpose. For a light emitting element of such indicators, it often happens that LEDs (Light Emitting Diodes) are adopted due to their lower consumption of electricity and high durability.

To make a LED emit light, such peripheral parts are must as a printed circuit board provided with an electric circuit to drive the LED, wiring and a holder to secure the LED in place. However, there are some cases according to the size of a product and spatial restriction in a portion where the indicator is incorporated and so on that disposing the LED on a portion where a light emitting section is provided faces problems.

With certain products having such restriction, there is a case where light emitted from the LED is guided to the light emitting section through a light guiding member. Typically, the light guiding member is designed by computing how light emitted from the LED is reflected and diffused to efficiently guide it to the light emitting section. In other words, on account that the shape of the light guiding member is optimized according to each product, problematically, the designed one is adoptable only for the specific product and is unable to be adopted for plural other products in common.

Against the above-mentioned problems, there is a method by which light emitted from the LED disposed on a portion with an extra room to spare is guided by the light guiding rod and irradiated at a portion where one likes. Just because the light guiding rod, typically, is smaller in thickness and flexible as represented by an optical fiber so as to be curved to some extent, it can be snugly fit into even a narrow portion.

The light guiding rod is arranged such that light incident on one end surface thereof is guided to the other end surface thereof for emission in such a manner that light penetrates and propagates through the inside of a cored layer. Now, there are some cases where light is not only incident in parallel with the light guiding rod, but also incident at a prescribed angle, but the components of light made incident with an angle going beyond a critical angle totally reflect on the boundary surface between the cored layer and the outer material of the cored layer due to difference in refractive index between them. This prevents light from being scattered on the boundary surface and its intensity from being attenuated and allows light to be guided afar without dissipation.

One concrete example of the light guiding rod makes use of difference in refractive index between the cored layer and the atmospheric layer facing externality from the cored layer.

However, when the cored layer is exposed to the atmosphere, the boundary surface between the cored layer and the atmospheric layer becomes vulnerable to be damaged, which results in the damaged surface entailing bumpy formation inviting light to be scattered and its intensity to be attenuated. Therefore, in many cases, what a layer of a certain thickness which is called a clad layer whose refractive index is lower than that of the cored layer is sheathed around the outer circumference of the cored layer to prevent the boundary surface from being exposed is adopted for the light guiding rod.

Incidentally, with the LED adopted for a light emitting element, the directivity of light irradiated therefrom is so wide that even the components of light made incident with an angle going below the critical angle based on difference in refractive index between the cored layer and the clad layer are incident on the cored layer. Further, there are some cases where the components of light which reached the boundary surface between the cored layer and the clad layer partly scatter. The components of light made incident with an angle going below the critical angle do not totally reflect on the boundary surface between the cored layer and the clad layer, but are refracted so that they penetrate from the cored layer to the clad layer. The components of light penetrated to the clad layer reach the boundary surface between the clad layer and the atmospheric layer facing externally from the clad layer, but most of them are emitted externally from the clad layer. Such leaked components irradiate the undesirable portions of a product to the detriment of its appearance and function.

Thus, conventionally, such light guiding rod is known as arranged such that the components of light are not leaked from the clad layer. In Document 1, there is disclosure on a plastic optical fiber comprising a clad layer made of a transparent inner clad layer and a colored and opaque outer clad layer.

According to the disclosure of Document 1, to begin with, a resin from which the inner clad layer is made is extruded in a tube-like manner while simultaneously a resin from which the outer clad layer is made and which is fusible to the resin from which the inner clad layer is made and contains a colorant is concentrically extruded to the outer circumference of the inner clad layer, thereby, a tube-like clad is formed in which the inner clad layer and the outer clad layer are integrally fused to each other. Then, the plastic optical fiber is produced by supplying a resinous precursor for the core to such tube-like clad under pressure while the resinous precursor being subjected to polymerization under heat.

Namely, this optical fiber is produced not by molding the cored layer and the clad layer at the same time, but by injecting under pressure a resin from which the cored layer is made into a hollow tube of the preliminarily molded clad layer.

### CITATION

### Patent Document

Document 1: Japanese Patent Laid-open Application No. H1 (1989)-229206

### SUMMARY OF INVENTION

### Problem to be Solved

However, with the prior art disclosed in Document 1, the tube-like clad layer must be preliminarily molded, which requires that such tube-like shape be kept intact after molding and have a thickness and a strength with which to stand the injection under pressure of the resin from which the cored layer is made. Thus, neither the clad layer nor a light-shielding layer can be overly thinned.

When the clad layer and the light-shielding layer become larger in thickness, it results in the diameter of the light guiding rod in its entirety becoming larger and its flexibility deteriorating, which problematically makes it hard to incorporate the light guiding rod into a product concerned.

Further, where the upper limit is defined for the outermost diameter of the light guiding rod due to its design specification, the clad layer and the light-shielding layer should be molded larger in thickness whereas the diameter of the cored layer should be relatively smaller in size. Therefore, the surface area of the end surface of the cored layer on which light irradiated by the LED is incident becomes smaller, which problematically leads to deteriorating efficiency with which to make light incident on such end surface, in turn, to reducing the emission intensity of the light emitting section.

Further, with the clad layer embodied in Document 1, there is possibility that it might be inflated during the injection under pressure of the cored layer owing to its thinness, which results in the diameter of the light guiding rod in its entirety becoming larger than that of the clad layer alone, so that there is likelihood that the outermost diameter of the light guiding rod which is allowable for its design specification might not be satisfied.

Furthermore, there are separate molding processes for the clad layer and the cored layer, which problematically leads to lowering production efficiency, in turn, to increasing the resulting product price.

In view of the foregoing, the present invention is to provide a light guiding rod of end surface light emitting type which is featured in preventing light from leaking from its periphery; enabling a light emitting element and a light emitting section to be disposed on different places from each other; and being capable of guiding light irradiated from the light emitting element with efficiency.

Further, the present invention is to provide a method of producing the light guiding rod of end surface emitting type in a cost-effective way or at an affordable market price.

### Solution to Problem

The means adopted by the inventors to solve the above-mentioned problem is elaborated as follows.

The light guiding rod of end surface light emitting type has the basic constitution comprising a bar-shaped cored layer essentially made from a resin having permeability of light and a clad layer which is disposed on the outer periphery of the cored layer and is essentially made from a resin whose refractive index is lower than that of the cored layer and has a function to emit light incident on one end surface of the cored layer from the other end surface thereof.

Now, what is mentioned here with ‘having permeability of light’ means having such permeability as enabling light whose intensity is strong enough for a product with a light guiding rod in use to be guided and as allowing not only visible light components, but also the light components other than the visible ones such as ultraviolet rays and infrared rays according to decorativeness and functionality to permeate through. Further, what is mentioned here with ‘essentially made from’ means that the proportional ratio in content of the resin is highest so that it is also inclusive of other materials.

The light guiding rod of end surface light emitting type according to the present invention is featured in addition to the above-mentioned basic constitution that a light shielding layer essentially made from a resin having a property to absorb the wavelengths of the light components penetrating through the cored layer is disposed on the outer periphery of the clad layer and the light-shielding layer is integrally fused to the clad layer.

Providing the light-shielding layer on the outer periphery of the clad layer allows the light components made incident at an angle below the critical angle and a part of the light components scattered on the boundary between the cored layer and the clad layer to be absorbed so that it can prevent such components from leaking to the atmosphere through the clad layer.

Further, integrally fusing the light-shielding layer to the clad layer makes it hard to happen that they are disengaged from each other by difference between them in the degree of expansion and contraction resulting from change in the atmospheric temperature and so forth and also even if their coefficients of linear expansion differ.

In addition, their integrally fused formation more readily enhances the physical strength compared with the case where they are independently formed, which results in such formation being able to be further made smaller in thickness, which leads to being able to make the diameter of the light guiding rod in its entirety smaller. It facilitates such rod to be flexibly curved to be readily incorporated into a product concerned. Further, providing that the light guiding rod is produced with the same physical strength, just because each of those layers can be made smaller in thickness while the diameter of the cored layer can be relatively made larger, so that even the light components emitted at a larger angle can permeate into the cored layer, with the result that efficiency with which to make such components incident on the cored layer can be enhanced.

Now, what is mentioned here with ‘a property to absorb the wavelengths of the light components penetrating through the cored layer’ not only refers to a black color known for absorbing the whole gamut of the wavelengths of the visible light components, but also refers to such a property as where the light components penetrating through the cored layer have the sole wavelength or a particular range of wavelengths, absorbing only such components having such sole wavelength or particular range of wavelengths while allowing the light components having other wavelengths to be reflected or transmitted through.

The means adopted according to the present invention to solve the above-mentioned problem in addition to the afore-said means also includes defining the thickness of the clad layer as equal to or less than 0.15 mm while defining the thickness of the light-shielding layer as equal to or less than 0.25 mm.

There are some cases where the outermost diameter of the light guiding rod is required to have a specific diameter according to the largeness of a space of a product into which such rod is incorporated and the standard of a ferrule terminal if such terminal is connected thereto. Providing that such rod is produced with the same outermost diameter, thinly forming the clad layer and the light-shielding layer such that the thickness of the former is defined as equal to or less than 0.15 mm while that of the latter is defined as equal to or less than 0.25 mm enables the diameter of the cored layer to be relatively made larger, so that the efficiency with which to make the light components incident on the cored layer can be enhanced. Further, where the diameter of the cored layer is predetermined according to the size of the light emitting element, the outermost diameter of the light guiding rod can be made smaller, so that such rod can be flexibly curved, which facilitates it to be incorporated into a product concerned.

Alternatively, a resin containing 0.01% or higher of carbon black by weight can be adopted for the material of the light-shielding layer.

The carbon black is of minute carbon particulates and especially has a property to intensively absorb the whole gamut of wavelengths of the visible light components. If the content of the carbon black is less than 0.01% by weight, the proportional ratio of the light components transmitting through the light-shielding layer increases, so that ample light-shielding performance is hard to get. On the other hand, adopting the resin containing 0.01% or higher of carbon black by weight for the light-shielding layer allows ample light-shielding performance to get even if whatever color the light emitting element may irradiate.

In turn, when the content of the carbon black within the resin from which the light-shielding layer is made goes beyond 5.0% by weight, there is likelihood that surface cracks might happen upon molding. Thus, it is desirable that its content be defined as equal to or less than 5.0% by weight.

Upon adopting the afore-mentioned means, a resin essentially made from an acryl-based elastomer is adopted for the material of the cored layer while a resin essentially made from a fluorine-based resin is adopted for the material of the clad layer. In this case, a resin having a glass transition temperature at which co-extrusion molding with the clad layer is feasible is adopted for the material of the light-shielding layer.

Adopting a resin essentially made from an acryl-based elastomer for the material of the cored layer allows the light guiding rod to be flexibly curved, so that it can snugly fit into the shape of a product concerned. Further, adopting a fluorine-based resin for the material of the clad layer and a resin having a glass transition temperature at which co-extrusion molding with the clad layer is feasible for the material of the light-shielding layer allows those layers to be integrally fused to each other through the molding process under the same conditions.

Further, it is also feasible to make the thickness of the light-shielding layer equal to or larger than 0.1 mm and to make the largeness of ‘a’ in the following equation that defines the relationship between the diameter of the light guiding rod in its entirety and its flexural modulus of elasticity equal to or larger than 550 but less than 3000 with reference to three-point flexural test based on JIS K 6911.

y=−43.054x+a, (Equation 1)

in which x stands for the diameter [mm] of the light guiding rod in its entirety while y stands for its flexural modulus of elasticity [MPa].

Making the thickness of the light-shielding layer equal to or larger than 0.1 mm securely prevents the light components from leakage from the periphery while the light-shielding layer becomes hardened due to the resulting content of the carbon black contained in the thickened light-shielding layer.

However, its flexural modulus of elasticity resulting from its three-point flexural test in which the largeness of ‘a’ in the equation is defined within the range equal to or larger than 550 but less than 3000 allows the light guiding rod to be readily and flexibly curved while successfully preventing the light components from leakage from the periphery.

With the method of producing the light guiding rod provided with a bar-shaped cored layer essentially made from a resin having permeability of light and a clad layer which is disposed on the outer periphery of the cored layer and is essentially made from a resin whose refractive index is lower than that of the cored layer, it is exemplified herein as follows.

A mold arranged such that a light shielding layer essentially made from a resin having a property to absorb the wavelengths of the light components penetrating through the cored layer is disposed on the outer periphery of the clad layer is made use of, and then the cored layer, the clad layer and the light-shielding layer are integrally molded to one another through co-extrusion.

As described above, co-extruding with the single mold the light shielding layer essentially made from a resin having a property to absorb the wavelengths of the light components penetrating through the cored layer together with the cored layer and the clad layer allows those layers to be integrally fused to one another through the molding process under the same conditions. In this way, since the clad layer and the light-shielding layer can be thinly formed while the dimeter of the cored layer can be relatively enlarged, the efficiency with which to make the light components incident on the cored layer can be enhanced. Integrally fusing those layers to one another through the molding process under the same conditions leads to streamlining the production process.

### Effect

As described above, with the light guiding rod of end surface light emitting type according to the present invention, it is arranged that the light-shielding layer essentially made from a resin having a property to absorb the wavelengths of the light components penetrating through the cored layer is disposed on the outer periphery of the clad layer. Further, it is arranged that the light-shielding layer and the clad layer are integrally fused to each other.

Such arrangements enable the light components leaking externally from the clad layer to be absorbed by the light-shielding layer so that it can prevent such components from leaking externally from the clad layer. Further, integrally fusing the clad and light-shielding layers to each other ensures steadfastness in shape even when the respective layers are thinly formed so that it can make the diameter of the light guiding rod in its entirety smaller and facilitate it to be flexibly curved while it can relatively enlarge the diameter of the cored layer, with the result that the efficiency with which to make the light components incident on the cored layer can be enhanced. According to advantageous effects brought by the foregoing, the light components do not leak from the periphery and the light emitting element and the light emitting section can be disposed on different places from each other, besides which the resulting light guiding rod of end surface light emitting type is capable of efficiently guiding the light components irradiated from the light emitting element.

In addition, according to the method of producing the light guiding rod of end surface light emitting type, it is arranged to simultaneously co-extrude with the single mold the light shielding layer essentially made from a resin having a property to absorb the wavelengths of the light components penetrating through the cored layer together with the cored layer and the clad layer, which allows those layers to be integrally fused to one another through the molding process under the same conditions.

This arrangement allows the light guiding rod of end surface emitting type to be produced in a cost-effective way or at an affordable market price.

### BRIEF DESCRIPTION OF DRAWINGS

FIG. 1 shows a perspective view and an enlarged cross-sectional view of the light guiding rod of end surface light emitting type according to the present invention.

FIG. 2 is an explanatory view to show how the light components proceed within the light guiding rod of end surface light emitting type according to the present invention.

FIG. 3 is a cross-sectional view showing an exemplary product with the light guiding rod of end surface light emitting type according to the present invention in use.

FIG. 4 is an explanatory view showing the method of producing the light guiding rod of end surface light emitting type according to the present invention.

FIG. 5 shows a perspective view and an enlarged cross-sectional view of the modified light guiding rod of end surface light emitting type according to the present invention.

FIG. 6 is a graph to show the distribution of flexural modulus of elasticity of the light guiding rod of end surface light emitting type according to the present invention and that of flexural modulus of elasticity of the conventional comparison examples.

### EMBODIMENT

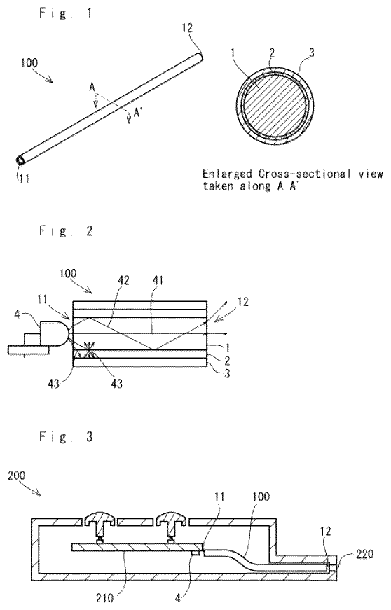

Hereafter, the mode for carrying out the present invention is explained based on FIG. 1 through FIG. 4.

To note, the drawings are exemplary-purpose only, and the depicted sizes and shapes are different from the actual ones.

The light guiding rod of end surface light emitting type 100 showing one example of the present invention, as illustrated in FIG. 1, comprises a bar-shaped cored layer 1 essentially made from a resin having permeability of light and a clad layer 2 which is disposed on the outer periphery of the cored layer 1 and essentially made from a resin whose refractive index is lower than that of the cored layer 1.

Further, a light-shielding layer 3 essentially made from a resin having a property to absorb the wavelengths of the light components penetrating through the cored layer is provided on the outer periphery of the clad layer 2.

Those layers 1, 2 and 3 are integrally fused to one another through the production method as described later.

According to the embodiment shown in FIG. 1, a block copolymer of methyl methacrylate-n-butyl acrylate-benzyl acrylate which is a flexible acryl-based elastomer is adopted for the main material of the cored layer 1, but one or plurality of a block copolymer (MMA-BA block copolymer) of methyl methacrylate and butyl acrylate, a block copolymer of methyl acrylate and butyl acrylate, an acryl-based block copolymer of methyl methacrylate (or methyl acrylate), ester acrylate and aromatic ester acrylate, polymethyl methacrylate (PMMA whose refractive index is 1.49), thermoplastic polyurethane (TPU whose refractive index is 1.49), cycloolefin (whose refractive index is 1.50), amorphous polyamide (whose refractive index is 1.51) and polycarbonate (PC whose refractive index is 1.56), each of which is a thermoplastic elastomer, is/are preferably adoptable for such main material.

In addition, the mixture of a flexible acryl-based elastomer and a rigid acryl-based resin whose glass transition temperature (Tg) is equal to or higher than the room temperature (25 degrees Centigrade) is adoptable for such main material, but what has a higher content of the acryl-based elastomer than the rigid acryl-based resin becomes more flexible. Besides, the other thermoplastic and thermosetting resins are adoptable for such main material just if they are extrusion-moldable.

Regarding the shape of the cored layer 1, according to the embodiment shown in FIG. 1, what is circular in cross section is illustrated, and its diameter is arbitrary, but it is preferable that its diameter be selected or defined as 6.3 mm, 3.5 mm, 2.5 mm and as such in accordance with the largeness of the light emitting surface of a lead frame type or shell-type LED and a surface mounting type LED. A semi-oval shape, a shape readily mountable into the internal structure of a product, an oval shape, a semi-circular shape, a polygonal shape and so on are also adoptable for the configuration thereof.

The cored layer 1 is arranged to be concentric with the clad layer 2 and the light-shielding layer 3, but it is feasible that the cored layer 1 is arranged to be eccentric with respect to the centers of the clad layer 2 and the light-shielding layer 3. In this case, it allows the light-shielding performance to be enhanced for the specific direction or facilitates the light guiding rod to be curved just to one direction.

On the other hand, according to the embodiment shown in FIG. 1, a copolymer of ethylene and tetrafluoroethylene (ETFE whose refractive index is 1.40 and which is a fluorine-based resin) is adopted for the main material of the clad layer 2, but one or plurality of a copolymer of hexafluoropropylene, tetrafluoroethylene and ethylene (EFEP whose refractive index is 1.38), polyvinylidenedifluoride (PVDF whose refractive index is 1.42), a copolymer of tetrafluoroethylene and perfluoroalkoxyethylene (PFA whose refractive index is 1.34), a copolymer of tetrafluoroethylene and hexafluoropropylene (FEP whose refractive index is 1.34) and polymethylpentene (TPX whose refractive index is 1.46) is/are preferably adoptable for such main material. Adopting a fluorine-based resin whose coefficient of friction is lower both for the main material of the clad layer 2 and that of the light-shielding layer 3 as described later facilitates the light guiding rod to be snugly inserted into or fitted into the internal structure of a product.

Further, such thermoplastic reins as polymethyl methacrylate (PMMA whose refractive index is 1.49), thermoplastic polyurethane (TPU whose refractive index is 1.49), cycloolefin (whose refractive index is 1.50), amorphous polyamide (PA whose refractive index is 1.51) and other thermosetting resins are adoptable for such main material, provided that those resins are extrusion-moldable and have a lower refractive index than that of the cored layer.

As for the shape of the clad layer 2, according to the embodiment shown in FIG. 1, such layer may we II be formed around the outer periphery of the cored layer 1 with a prescribed thickness, and it is preferable that its thickness be equal to or smaller than 0.15 mm for the purpose of facilitating the light guiding rod to be curved with the overall diameter thereof reduced or enhancing the efficiency with which to make the light components incident on the cored layer with the diameter of the cored layer 1 relatively enlarged, more preferably, its thickness being equal to or smaller than 0.1 mm and further preferably being equal to or smaller than 0.05 mm.

In addition, the clad layer 2 may well be of one-layered structure or multi-layered structure comprising a plurality of clad layers 2.

Preferably, defining difference in refractive index between the cored layer 1 and the clad layer 2 as equal to or larger than 0.01 facilitates the light components to totally reflect on the boundary surface between those layers, thereby, allowing such components to be guided with efficiency, but it is further preferable that such difference be equal to or larger than 0.07.

Further, what 0.01% by weight of carbon black is contained is adopted for the material of the light-shielding layer 3. The carbon black consists of minute carbon powders whose particulate diameter ranges from several nm to several hundred nm and can be selected from what exclusively consists of carbon atoms and what has a composition in which various functional groups are coupled to one another on the surface, provided that those options have a property to intensively absorb the range of wavelengths of the prescribed light components.

The carbon black by content is defined as from equal to or larger than 0.01% by weight to equal to or less than 5.0% by weight, preferably, being from equal to or larger than 0.2% by weight to equal to or less than 5.0% by weight, further preferably, being from equal to or larger than 0.8% by weight to equal to or less than 5.0% by weight taking into due considerations stable light-shielding performance and preventing molding defects such as cracks.

Copper oxide-based or iron oxide-based complex oxides, titanium-based black pigments are adoptable for a black colorant to be contained in the light-shielding layer 3, by way of some examples, and provided that the light components to be guided within the cored layer 1 are of the single-colored ones having a specific range of wavelengths for example, such a color pigment as being arranged to exclusively absorb such single-colored components is adoptable for such colorant.

As for the main material of the light-shielding layer 3, it is must that it can be integrally fused to the clad layer 2 through simultaneous co-extrusion molding, in which the copolymer (ETFE) of ethylene and tetrafluoroethylene which is a fluorine-based resin is adoptable for such main material in the same way as for the clad layer 2, but one or plurality of a copolymer (EFEP) of hexafluoropropylene, tetrafluoroethylene and ethylene, polyvinylidene difluoride (PVDF), a copolymer of tetrafluoroethylene and perfluoroalkoxyethylene (PFA), a copolymer of tetrafluoroethylene and hexafluoropropylene (FEP) and as such is/are preferably adoptable for such main material.

Additionally, such thermoplastic resins as soft polyvinyl chloride (PVC), olefin-based thermoplastic elastomer (TPO), styrene-based thermoplastic elastomer (TPS), thermoplastic polyurethane (TPU), thermoplastic elastomer (TPE) and polyamide-based thermoplastic elastomer (TPA) and other thermosetting resins are adoptable for such main material, provided that they are extrusion-moldable resins, and besides the foregoing resins, what is extrusion-moldable together with the clad layer 2 through co-extrusion molding and has almost the same glass transition temperature as that of the main material from which the clad layer 2 is made is also selectable for the main material of the light-shielding layer.

Regarding the shape of the light-shielding layer 3, according to the embodiment shown in FIG. 1, it is just fine if it is formed on the outer periphery of the clad layer 2 with a prescribed thickness, but in considerations of counterbalancing between the reasons behind the thickness selection of the clad layer 2 as discussed above and obtaining sufficient light-shielding performance, it is preferable that its thickness be equal to or less than 0.25 mm, further preferably, being equal to or less than 0.2 mm.

In addition, the light-shielding layer 3 may well be of one-layered structure or multi-layered structure comprising a plurality of light-shielding layers 3.

To note, the light guiding rod of end surface light emitting type 100 according to the present invention envisages preventing the light components from being emitted from its circumferential surface and emitting light just from its end surface, so that any light scattering agent such as titanium oxide is not contained neither in the cored layer 1 nor in the clad layer 2 according to the embodiment shown in FIG. 1. However, as the light-shielding layer 3 prevents the light components from being emitted from its circumferential surface, so that such agent may well be contained in the cored layer 1 for the purpose of having uniform diffused light emitted from its end surface.

With the light guiding rod of end surface light emitting type 100 according to the embodiment shown in FIG. 1, when it is not used with exposed to sunlight outdoors, it is unnecessary to incorporate a bluing agent into the cored layer 1. However, when visible-spectrum LEDs and UV-spectrum LEDs are jointly used by way of one example, there are some cases where the cored layer 1 is tinged with yellowish tone by ultraviolet rays and the color tone of emitted visible light is altered, so that such bluing agents as a blue pigment may well be incorporated into the cored layer 1.

Then, the movement of the light components traveling within the light guiding rod of end surface light emitting type 100 is explained with reference to FIG. 2. In FIG. 2, the light emitted from a LED 4 which is a light emitting element is made incident on an end surface 11 of the cored layer 1. Among the light components made incident thereon, parallel components 41 made incident on a direction parallel to the longitudinal direction of the cored layer 1 travel straight within the cored layer 1.

In turn, among the light components made incident with a prescribed angle onto the longitudinal direction of the cored layer 1, components 42 made incident with an angle going beyond the critical angle travel within the cored layer 1 with repetitiously totally reflecting on the boundary surface between the cored layer 1 and the clad layer 2.

However, components 43 made incident with an angle going below the critical angle do not totally reflect on such boundary surface and go into the clad layer 2 with refraction. Further, even when the light components are made incident with an angle going beyond the critical angle, some scattered light components occur on the boundary surface between the cored layer 1 and the clad layer 2. A part of such scattered light components goes into the clad layer 2. Such components found in the clad layer 2 reach the boundary surface between the clad layer 2 and the light-shielding layer 3. At this moment, the carbon black and particles of the color pigment contained in the resin from which the light-shielding layer 3 is made absorb such components found on the boundary surface between the clad layer 2 and the light-shielding layer 3. In this way, by the light components reached the light-shielding layer 3 from the clad layer 2 being absorbed, it can prevent such components from being leaked to the atmosphere, besides which there is no case where such components return to the cored layer 1, so that it can prevent the directivity of the light emitted from the end surface from showing unintended characteristics as well.

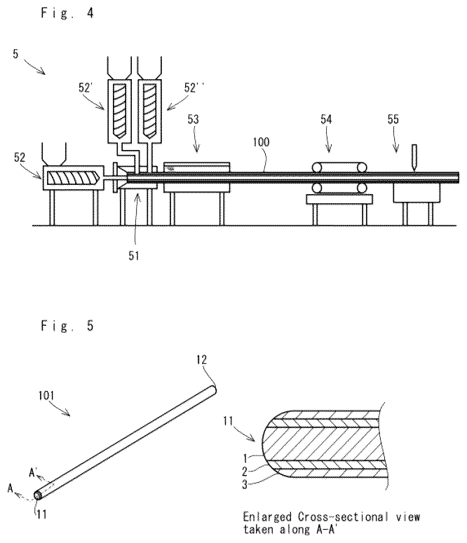

The light guiding rod of end surface light emitting type 100 having the above-mentioned features, as illustrated in FIG. 3, is incorporated into a product 200 and constitutes a part of the indicator which emits light at its arbitrary portions.

According to the embodiment shown in FIG. 3, the product 200 is a part of the housing of an electric appliance by way of one example. Although the interior of the product 200 is mostly wide in space, the right-hand side portion thereof where the indicator is disposed becomes narrower in space. When the LED 4 is disposed at such right-hand side portion narrower in space, there is no disposing a printed circuit board 210 to drive the LED 4 there even if the LED 4 is a surface mounting type LED smaller in size.

Thus, the printed circuit board 210 carrying the LED 4 is disposed in a portion of the product 200 wider in space and the light guiding rod of end surface light emitting type 100 is disposed such that its one end surface 11 is in proximity with the light emitting surface of the LED 4. Then, its other end surface 12 is disposed oppositely to a light emitting section 220 with the light guiding rod of end surface light emitting type 100 running along the interior of the product 200.

The above arrangement allows the light emitting section 220 to be provided on such an inner structural portion with a narrow space as being unable to dispose the LED 4 together with the printed circuit board 210 to drive it, so that any arbitrary portion can be secured for the indicator. Further, since the light guiding rod of end surface light emitting type 100 is so flexible that its length can be readily modified, it dispenses with designing and producing the light guiding rod exclusively for each individual product. Thus, the light guiding rod of end surface light emitting type 100 can be used as a structural component for various products in common, so that manufacturing cost and parts management man-hours can be reduced.

Now, the method of producing the light guiding rod of end surface emitting type 100 is explained with reference to FIG. 4. The claimed light guiding rod 100 is produced through co-extrusion molding with the cored layer 1, the clad layer 2 and the light-shielding layer 3 integrally fused to one another at the same time.

The claimed method uses a production device 5 as illustrated in FIG. 4 and is provided with a mold 51 arranged such that the cored layer 1, the clad layer 2 and the light-shielding layer 3 are made concentric to one another. To the respective portions of the mold 51 where the cored layer 1, the clad layer 2 and the light-shielding layer 3 are formed, cylinders 52, 52′ and 52‘ ’ to inject the corresponding resins are respectively connected, in which such resins are input to the respective hoppers and the fused resins are fed into the mold 51 with the screws.

Within the mold 51, the fused resins of the cored layer 1, the clad layer 2 and the light-shielding layer 3 are molded according to the shape thereof and those layers are integrally fused to one another to be extruded. The resulting work in process subjected to the extrusion molding is cooled and solidified in a cooling water tank 53 and the cooled and solidified work in process is taken out by a take-out device 54 and cut off into a predetermined length with a cutter 55.

As described above, integrally fusing the cored layer 1, the clad layer 2 and the light-shielding layer 3 to one another at the same time through co-extrusion molding allows the claimed light guiding rod 100 to be produced through the sole manufacturing process, which leads to reducing manufacturing cost.

### Modified Example

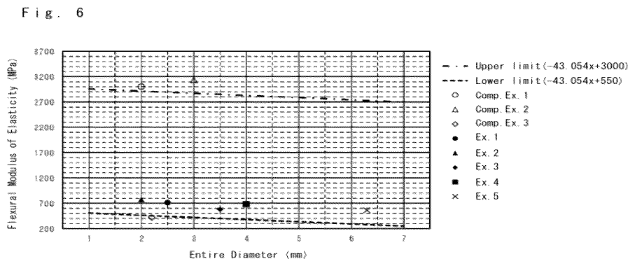

By the way, the light guiding rod of end surface light emitting type according to the present invention is not limited to the above-mentioned embodiment, but can be carried out according to another mode. The light guiding rod of end surface light emitting type 101 according to the modified example illustrated in FIG. 5 differs from the embodiment illustrated in FIG. 1 in that the end surface 11 is subjected to grinding or polishing process into a convex lens shape.

To improve the efficiency with which the light components are guided, it requires that as many light components as possible be made incident at an angle beyond the critical angle. However, with LEDs, generally speaking, the light components are emitted to every direction from their semiconductors. The directivity of the emitted light components is slightly narrowed by reflectors and the shape of a resinous package, but is relatively wider. Thus, when the end surface of the cored layer 1 is flat, the proportionally large light components below the critical angle are made incident onto the cored layer 1 while such components cannot be totally reflected, so that the efficiency with which to guide such components deteriorates.

Therefore, grinding or polishing the end surface 11 onto which the light components are made incident into a convex lens shape allows such components made incident through such convex shape to be refracted, thereby, their directivity being narrowed. In other words, the incident angle with respect to the clad layer 2 becomes larger so that the proportion of such components beyond the critical angle becomes enhanced. Thus, as many light components as possible can be totally reflected and guided.

To note, according to the modified example, the other end surface 12 remains flat, but it can be worked into a satin finish. This way, the light components emitted from the end surface 12 can be dispersed. Thus, where the light guiding rod is incorporated into a product, it can dispense with providing a separate window or a lens component as an indicator, rather, such end surface 12 can be turned into an indicator window with directly exposed.

As described above, with the inventive light guiding rod of end surface light emitting type, making the light components made incident onto the one end surface emit from the other end surface allows a LED and a light emitting section to be disposed to different places from each other even when the relevant product has such a structure as being unable to incorporate a LED and its other peripheral parts into the light emitting section.

Further, integrally fusing the light-shielding layer and the clad layer to each other prevents the light components from leakage from the peripheral surface as well as allows those layers to be formed as thinly as possible. Thus, the diameter of the light guiding rod in its entirety can be made smaller and flexibly curved to be readily incorporated into a product concerned. On the other hand, providing that the light guiding rod in its entirety is produced with the same diameter, the diameter of the cored layer can be relatively made larger, so that the efficiency with which the light components are made incident improves, which enables the light emitting section to be made brighter.

### Examples

Now, durability tests or bending test and three-point flexural test have been performed on the concrete examples of the inventive light guiding rod and the comparison ones of the conventional counterparts and their results have been compared with one another.

### First Example

The first example is such that the light guiding rod in its entirety has 2.5 mm in diameter, in which the diameter of the cored layer circular in cross section is defined as 2 mm and the clad layer having 0.05 mm in thickness is provided around the periphery of the cored layer and the light-shielding layer having 0.2 mm in thickness is provided on the periphery of the clad layer.

A color less and transparent polymethylmethacrylate (PMMA) based elastomer resin is adopted for the material of the cored layer while a copolymer of ethylene and tetrafluoroethylene (a colorless and transparent ETFE resin) is adopted for the material of the clad layer. A fluorine-based resin arranged to contain 0.9% by weight of carbon black to the relevant product in its entirety is adopted for the material of the light-shielding layer.

### Second Example

The second example is such that the light guiding rod in its entirety has 2 mm in diameter, in which excepting that the diameter of the cored layer is defined as 1.5 mm, the other arrangements are the same as those of the first example.

### Third Example

The third example is such that the light guiding rod in its entirety has 3.5 mm in diameter, in which excepting that the diameter of the cored layer is defined as 3 mm, the other arrangements are the same as those of the first example.

### Fourth Example

The fourth example is such that the light guiding rod in its entirety has 4 mm in diameter, in which excepting that the diameter of the cored layer is defined as 3.5 mm, the other arrangements are the same as those of the first example.

### Fifth Example

The fifth example is such that the light guiding rod in its entirety has 6.3 mm in diameter, in which excepting that the diameter of the cored layer is defined as 5.8 mm, the other arrangements are the same as those of the first example.

### First Comparison Example

The first comparison example is such that the light guiding rod in its entirety has 2.04 mm in diameter, in which the diameter of the cored layer circular in cross section is defined as 2 mm and the clad layer having 0.02 mm in thickness is provided around the periphery of the cored layer and there is no provision of the light-shielding layer.

A colorless and transparent PMMA resin is adopted for the material of the cored layer while a colorless and transparent PVDF (polyvinylidene difluoride) resin is adopted for the material of the clad layer.

### Second Comparison Example

The second comparison example is such that the light guiding rod in its entirety has 3 mm in diameter, in which the diameter of the cored layer circular in cross section is defined as 2.98 mm and the clad layer having 0.01 mm in thickness is provided around the periphery of the cored layer and there is no provision of the light-shielding layer.

A colorless and transparent PMMA resin is adopted for the material of the cored layer while a colorless and transparent fluorine-based resin is adopted for the material of the clad layer.

### Third Comparison Example

The third comparison example is such that the light guiding rod in its entirety has 2.2 mm in diameter, in which the diameter of the cored layer circular in cross section is defined as 0.98 mm and the clad layer having 0.01 mm in thickness is provided around the periphery of the cored layer and the light-shielding layer having 0.6 mm in thickness is provided on the periphery of the clad layer.

A colorless and transparent PMMA resin is adopted for the material of the cored layer while a colorless and transparent fluorine-based resin is adopted for the material of the clad layer. A polyethylene resin black in color is adopted for the material of the light-shielding layer.

### Bending Test

Three kinds of 100 mm, 200 mm and 300 mm in length are arranged for each sample for the bending test under the above-mentioned respective conditions.

The method of performing the bending test is as follows: holding both ends of a sample with hands; the sample is folded by 180 degrees to the one direction such that one end thereof is aligned with the other end thereof; and the bended section is forcedly pinched with fingers such that the doubled portions are adhered to each other and then folded to the other direction and pinched in the same way. Those actions are alternately repeated five times.

The samples subjected to the bending test correspond to the first example, the first and second comparison examples, the sample size (N) of each of which is 3.

Further, the attenuation of amount of light permeated before and after the test is measured. A spectral radiance meter is adopted for measuring it at a position 200 mm away from the radiant end surface with the light source red in color, the driving current and lumen of which are 300 mA and 3.634 lm respectively.

### Test Result

Any of the samples with three kinds of length according to the first example has not been subjected to breakage and free from crack and tear on the light-shielding layer. The average lumen after the test has turned out to be 92% compared with that before the test.

On the other hand, the samples according to the first and second comparison examples have broken at the first bending and when they have been folded back to the other direction.

### Three-Point Flexural Test

What has 100 mm in length is arranged for each sample under the above-mentioned respective conditions.

The method of performing this test has been carried out in comply with JIS K 6911.

At the test, the stroke and load of an indenter have been measured and the calculated results of the flexural strain and the flexural stress have led to a stress-strain diagram.

The flexural modulus of elasticity has been calculated from each stress at the strain of 0.05% and that of 0.25% of the stress-strain diagram (according to secant method). To note, the flexural modulus of elasticity may well be calculated using (tangent method) by which it is calculated from the gradient of a straight line of loads between prescribed strokes.

### Test Result

The test result of each sample is shown in the following table.

TABLE 1

| | Entire | Diameter | Thickness | Thickness of | Flexural |
|---|---|---|---|---|---|
| | Diameter | of Cored | of Clad | Light-shielding | Modulus of |
| | (mm) | Layer (mm) | Layer (mm) | Layer (mm) | Elasticity (MPa) |
| Ex. 1 | 2.5 | 2 | 0.05 | 0.2 | 711 |
| Ex. 2 | 2 | 1.5 | 0.05 | 0.2 | 771 |
| Ex. 3 | 3.5 | 3 | 0.05 | 0.2 | 576 |
| Ex. 4 | 4 | 3.5 | 0.05 | 0.2 | 680 |
| Ex. 5 | 6.3 | 5.8 | 0.05 | 0.2 | 561 |
| Comp. Ex. 1 | 2 | 1.6 | 0.2 | N/A | 2999 |
| Comp. Ex. 2 | 3 | 2.6 | 0.2 | N/A | 3135 |
| Comp. Ex. 3 | 2.2 | 0.98 | 0.01 | 0.6 | 418 |

FIG. 6 illustrates what the flexural moduli of elasticity listed in the above table are plotted on a scatter diagram.

The thickness of the clad layer and the light-shielding layer respectively is the same over the first to fifth examples while the diameter of the cored layer is different from each other. Since an acryl-based elastomer is adopted for the material of the cored layer so that it is soft to the texture, the diameter of the cored layer can be enlarged, with the result that the larger the proportional occupancy of the cored layer becomes, there is tendency that the lower the flexural modulus of elasticity becomes smaller.

With the examples according to the present invention, the light shielding layer has 0.2 mm in thickness so that it is relatively thicker and it contains carbon black so that it is hard to be bent.

However, it is derived from the above-mentioned bending test and three-point flexural test that the flexural moduli of elasticity are distributed between the upper and lower limits shown in FIG. 6 by the light-shielding performance being enhanced with a predetermined amount of carbon black contained in the fluorine-based resin while the material and diameter of the cored layer being exquisitely adjusted according to the inventive examples. This distributed range corresponds to what the largeness of ‘a’ in the following equation is equal to or more than 550, but less than 3000.

y=−43.054x+a, (Equation 1)

in which x stands for the diameter [mm] of the light guiding rod in its entirety while y stands for its flexural modulus of elasticity [MPa].

Providing that the largeness of ‘a’ in the preceding equation is equal to or more than 550, but less than 3000, the light guiding rod becomes flexible and easy to be bent, in which there is no case where it is yielding to breakage or leakage of light happens through the damage of the light-shielding layer. Especially, in light of achieving both flexibility and anti-bending performance, it is preferred that the largeness of ‘a’ be equal to or more than 600, but less than 2000; being further preferred that it be equal to or more than 650, but less than 1000; and being by far preferred that it be equal to or more than 700, but less than 900.

As mentioned above, the inventive light guiding rod is characterized in being soft to the texture and hard to be broken, though it is provided with the light-shielding layer in which carbon black having light-shielding effect and hardening effect is contained. Therefore, it allows the light emitting element and the light emitting section can be disposed on different places from each other, on top of which the light components emitted from the light emitting element can be guided with efficiency without such components being leaked from the circumferential section.

### LISTING OF REFERENCED NUMBERS

100, 101 Light guiding rod of end surface light emitting type
1 Cored layer
   11 One end (of cored layer)
   12 The other end (of cored layer)
2 Clad layer
3 Light-shielding layer
4 LED
   41 Parallel components
   42 Components made incident with an angle going beyond the critical angle
   43 Components made incident with an angle going below the critical angle
5 Production device
   51 Mold
   52 Cylinder
   53 Cooling water tank
   54 Take-out device
   55 Cutter
200 Product
210 Printed circuit board
220 Light Emitting Section

1. A light guiding rod of end surface light emitting type comprising a bar-shaped cored layer essentially made from a resin having permeability of light and a clad layer which is disposed on an outer periphery of the cored layer and is essentially made from a resin whose refractive index is lower than that of the cored layer and emitting light incident on one end surface of the cored layer from the other end surface thereof, wherein a light shielding layer essentially made from a resin having a property to absorb wavelengths of light components penetrating through the cored layer is disposed on an outer periphery of the clad layer and the light-shielding layer is integrally fused to the clad layer.

2. The light guiding rod of end surface light emitting type according to claim 1 defining a thickness of the clad layer as being equal to or less than 0.15 mm while defining a thickness of the light-shielding layer as being equal to or less than 0.25 mm.

3. The light guiding rod of end surface light emitting type according to claim 1 wherein a resin containing 0.01% or higher of carbon black by weight is adopted for a material of the light-shielding layer.

4. The light guiding rod of end surface light emitting type according to claim 1 wherein a resin essentially made from an acryl-based elastomer is adopted for the material of the cored layer while a resin essentially made from a fluorine-based resin is adopted for the material of the clad layer in the meantime a resin having a glass transition temperature at which co-extrusion molding with the clad layer is feasible is adopted for the material of the light-shielding layer.

5. The light guiding rod of end surface light emitting type according to claim 3 wherein the thickness of the light-shielding layer is equal to or larger than 0.1 mm and a largeness of ‘a’ in the following equation that defines the relationship between a diameter of the light guiding rod in its entirety and its flexural modulus of elasticity is equal to or larger than 550 but less than 3000 with reference to three-point flexural test:
y=−43.054x+a, (Equation 1)
in which x stands for the diameter [mm] of the light guiding rod in its entirety while y stands for its flexural modulus of elasticity [MPa].

6. A method for producing a light guiding rod of end surface light emitting type comprising a bar-shaped cored layer essentially made from a resin having permeability of light and a clad layer which is disposed on an outer periphery of the cored layer and is essentially made from a resin whose refractive index is lower than that of the cored layer and emitting light incident on one end surface of the cored layer from the other end surface thereof, the method making use of a mold arranged such that a light shielding layer essentially made from a resin having a property to absorb wavelengths of light components penetrating through the cored layer is disposed on an outer periphery of the clad layer and including a step of integrally molding the cored layer, the clad layer and the light-shielding layer to one another through co-extrusion.

7. The light guiding rod of end surface light emitting type according to claim 2 wherein a resin containing 0.01% or higher of carbon black by weight is adopted for a material of the light-shielding layer.

8. The light guiding rod of end surface light emitting type according to claim 2 wherein a resin essentially made from an acryl-based elastomer is adopted for the material of the cored layer while a resin essentially made from a fluorine-based resin is adopted for the material of the clad layer in the meantime a resin having a glass transition temperature at which co-extrusion molding with the clad layer is feasible is adopted for the material of the light-shielding layer.

9. The light guiding rod of end surface light emitting type according to claim 4 wherein the thickness of the light-shielding layer is equal to or larger than 0.1 mm and a largeness of ‘a’ in the following equation that defines the relationship between a diameter of the light guiding rod in its entirety and its flexural modulus of elasticity is equal to or larger than 550 but less than 3000 with reference to three-point flexural test:
y=−43.054x+a, (Equation 1)
in which x stands for the diameter [mm] of the light guiding rod in its entirety while y stands for its flexural modulus of elasticity [MPa].

10. The light guiding rod of end surface light emitting type according to claim 7 wherein the thickness of the light-shielding layer is equal to or larger than 0.1 mm and a largeness of ‘a’ in the following equation that defines the relationship between a diameter of the light guiding rod in its entirety and its flexural modulus of elasticity is equal to or larger than 550 but less than 3000 with reference to three-point flexural test:
y=−43.054x+a, (Equation 1)
in which x stands for the diameter [mm] of the light guiding rod in its entirety while y stands for its flexural modulus of elasticity [MPa].

11. The light guiding rod of end surface light emitting type according to claim 8 wherein the thickness of the light-shielding layer is equal to or larger than 0.1 mm and a largeness of ‘a’ in the following equation that defines the relationship between a diameter of the light guiding rod in its entirety and its flexural modulus of elasticity is equal to or larger than 550 but less than 3000 with reference to three-point flexural test:
y=−43.054x+a, (Equation 1)
in which x stands for the diameter [mm] of the light guiding rod in its entirety while y stands for its flexural modulus of elasticity [MPa].
